(19) United States
(12) Patent Application Publication
(10) Pub. No.: US 2008/0132210 A1
(43) Pub. Date: Jun. 5, 2008

(54) METHOD AND APPARATUS FOR ENHANCED IDENTIFICATION OF INDIVIDUAL(S)

(76) Inventors: Jose E. Korneluk, Boynton Beach, FL (US); Dale R. Crosby, Coral Springs, FL (US); Scott M. Garrett, Weston, FL (US); Von A. Mock, Boynton Beach, FL (US); Jorge L. Perdomo, Boca Raton, FL (US)

Correspondence Address: MOTOROLA, INC, 1303 EAST ALGONQUIN ROAD, IL01/3RD, SCHAUMBURG, IL, 60196, US

(21) Appl. No.: 11/155,280

(22) Filed: Jun. 17, 2005

(51) Int. Cl. H04Q 7/38; G08B 5/22; H04Q 5/22; G08B 1/08; G08B 23/00

(52) U.S. Cl. 455/414.1; 340/539.11; 340/573.1; 340/10.31; 340/7.2

(57) ABSTRACT

The present invention provides a method (200) and apparatus (700 and 800) for identifying individuals in a crowd. The method comprises the steps of selecting an identification signal (204), sending the identification signal (206) to the electronic device (802) of an individual/individuals to be identified by using an electronic device (702), available with the user; and selectively activating (208) the electronic device (802). The user can identify the individual based on the activated electronic device.

### BACKGROUND OF THE INVENTION

1. Field of the Invention

This invention relates in general to the identification of individuals, and more specifically to a method and apparatus for identification of individuals by activating their electronic devices.

2. Description of the Related Art

Identification of individuals becomes a necessity in various situations. The activity of identifying and locating an individual or a group of individuals in a crowd may take a significant amount of time. For example, in a low light environment, it may be a difficult and time-consuming task to identify an individual or a group of individuals. In certain cases, it may be necessary to establish the authenticity of individuals. For example, an individual may want to verify the authenticity of law enforcement personnel. Further, there may be cases where it may become necessary to track individuals. For example, a police officer wants to track a suspected individual without his/her knowledge.

### SUMMARY OF THE INVENTION

The present invention generally concerns a method for identifying one or more individuals, such as in a crowd. In one arrangement, the method can include the steps of selecting an identification signal, sending the identification signal to the electronic devices of the individuals to be identified, and selectively activating the electronic devices. As an example, the electronic device can be a mobile device, such as a cellular telephone or a two-way radio. A user can identify the individuals based on the activated electronic devices. The step of selecting the identification signal can include the step of selecting the identification signal through an electronic device or a network.

The step of selectively activating the electronic devices can include the step of selectively activating a color display, a speaker, a vibrator, or a non-visible light source of the electronic devices or any combination thereof. The color display can be activated in such a way that a predetermined color display signal or a predetermined pattern is displayed based on functions of the one or more individuals.

In another arrangement, the method can further comprise the step of tracking the location of the individuals without their knowledge. The step of tracking the location of the individuals can comprise the step of selectively activating the non-visible light sources of the electronic devices of the individuals.

The method can further comprise the step of deactivating the activated electronic devices. In one arrangement, the deactivation of the activated electronic devices can be done after the individuals have been identified.

In one arrangement, the method can further comprise the step of locking the electronic devices of the individuals to be identified. In the step of locking, the deactivation of the activated electronic devices can be prevented. In another arrangement, the deactivation of the activated electronic devices can be prevented until a set of predefined conditions is satisfied.

In another arrangement, the step of selecting the identification signal can include selecting the identification signal through an electronic device or a network. Also, the electronic devices of the one or more individuals to be identified can be selectively activated when the electronic devices are within a predetermined geographical region.

The present invention also concerns an electronic device for identifying one or more individuals in a crowd. In one arrangement, the electronic device can comprise a selection module that can select an identification signal that can be used to identify one or more individuals in the crowd and a communication module. The communication module can send the identification signal to the electronic devices of the one or more individuals to be identified. The identification signal can selectively activate an activation module on the electronic devices of the individuals to be identified to allow a user to identify one or more of the individuals. The electronic device can include suitable software and circuitry for carrying out the processes described above.

The present invention further concerns another electronic device for identifying one or more individuals in a crowd. The electronic device can comprise a communication module that can receive an identification signal from an originating component and can include an activation module. The identification signal can be used to identify one or more individuals in a crowd having the electronic device. The activation module activates in response to the receipt of the identification signal to allow a user to identify the one or more individuals having the electronic device. As an example, the activation module can selectively activate a color display, a speaker, a vibrator, and a non-visible light source present on the electronic device in response to the receipt of the identification signal. This electronic device can also include suitable software and circuitry for carrying out the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an operational environment, in accordance with an embodiment of the inventive arrangements;

FIG. 2 illustrates a method for identifying individuals, in accordance with an embodiment of the inventive arrangements;

FIG. 3 illustrates a method for selecting an identification signal, in accordance with an embodiment of the inventive arrangements;

FIG. 4 illustrates a method for authenticating individuals, in accordance with an embodiment of the inventive arrangements;

FIG. 5 illustrates a method for remotely using another individual's electronic device for one's own purpose, in accordance with an embodiment of the inventive arrangements;

FIG. 6 illustrates a method for identifying the type of incoming call, in accordance with an embodiment of the inventive arrangements;

FIG. 7 illustrates an electronic device for identifying individuals, in accordance with an embodiment of the inventive arrangements; and

FIG. 8 illustrates another electronic device for identifying individuals, in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

The invention concerns a method and apparatus for identifying individuals in a crowd. The crowd can comprise one or more individuals. In addition, the term “individual” can include human beings, animals or machines. In one arrangement, the method can include the steps of selecting an identification signal, sending the identification signal to the electronic devices of the individuals to be identified, and selectively activating the electronic devices of the individuals to be identified. A user can identify the individuals based on the activated electronic devices.

As an example, a user can select a color and assign the selected color to the individual(s) to be identified. The user can then send to the electronic devices of the individual(s) to be identified a request for displaying the selected color display signal at the electronic devices. The individuals' electronic devices can display the selected color and the user can identify the individuals by the displayed color.

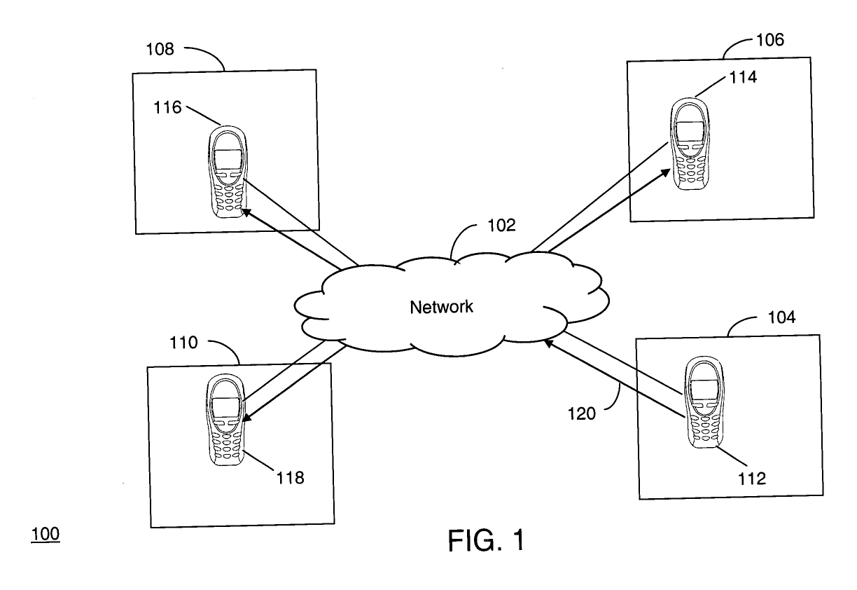

Referring to FIG. 1, an operational environment 100 in which the invention works is shown. In one arrangement, the operational environment 100 can include a user 104 and multiple individuals 106, 108 and 110. The user 104, the individual 106, the individual 108, and the individual 110 have electronic devices 112, 114, 116 and 118, respectively. The electronic devices 112, 114, 116 and 118 can be connected through a network 102. Communication in the network 102 can be based on frequency division multiple access (FDMA), time division multiple access (TDMA), code division multiple access (CDMA), or any other suitable communication standard or protocol.

The electronic devices 112, 114, 116 and 118 can be cellular telephones, two-way radios or personal digital assistants, although the invention is not limited to these examples. Those of skill in the art will also appreciate that the electronic devices may also communicate directly with one another, i.e., without the assistance of the network 102.

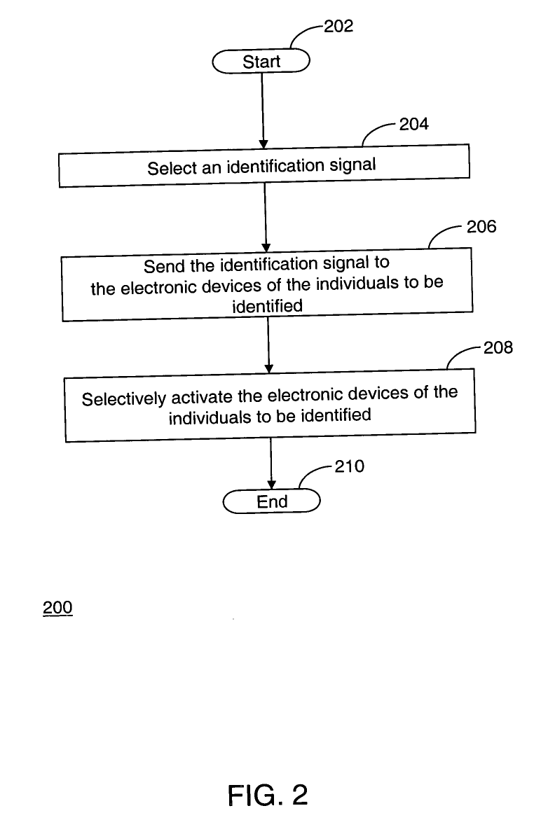

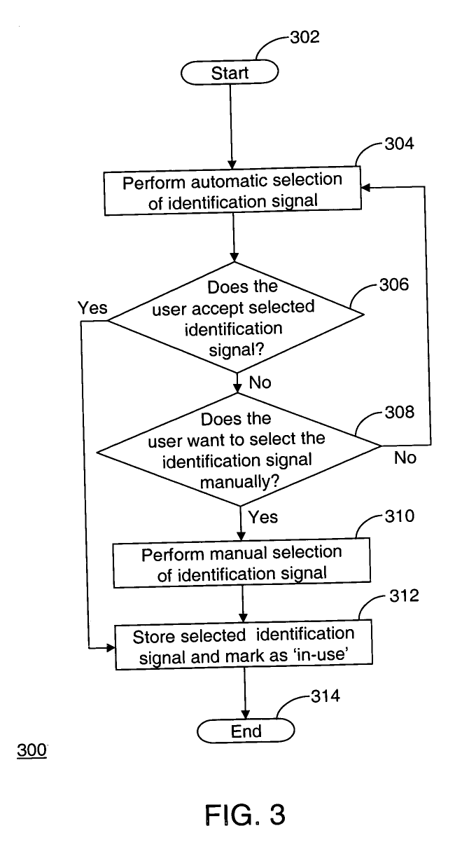

The user 104 can select an identification signal 120 and send it to the individuals 106, 108 and 110. The identification signal 120 can be a color display signal, an audio signal, a vibratory signal, or a non-visible light signal. The identification signal 120 can also be any combination of a color display signal, audio signal, vibratory signal, and non-visible light signal. An electronic device can have, for example, a display, a bank of LEDs, a speaker, a vibrator, or a non-visible light source that can be activated by the respective identification signals. Further, different combinations of the same identification signal can be achieved by varying the parameters of the identification signal. A large number of combinations of identification signals can be achieved by varying the signal-specific parameters. For example, in the case of color display signal, the parameters can include color, brightness, turn on/off slopes and blinking patterns. The selection and sending of the identification signal 120, and activation of the electronic devices can be further explained in conjunction with FIGS. 2 and 3.

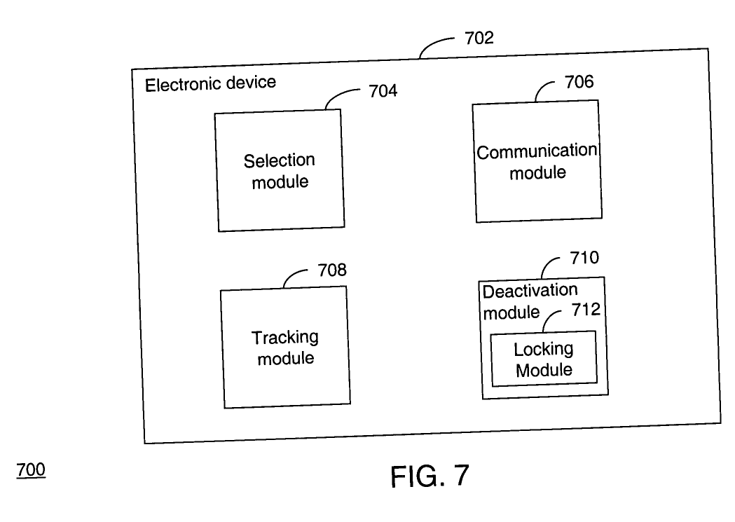

Referring to FIG. 2, a method 200 for identifying individuals is shown. The method 200 can be implemented in a system or suitable device other than the one shown in FIG. 7. Moreover, the invention is not limited to the order in which the steps are listed in the method 200. In addition, the method 200 can contain a greater or fewer numbers of steps than those shown in FIG. 2.

Consider a case in which the user 104 wants to identify the individual 106 (see FIG. 1). At step 202, the method 200 can begin. To achieve this objective, the user 104 can select an identification signal at step 204. The selection of the identification signal can be further explained in conjunction with FIG. 3.

FIG. 3 illustrates a method 300 for selecting an identification signal. The identification signal can be selected automatically as well as manually. At step 302, the method 300 can begin. At step 304, the identification signal can be selected automatically. In one embodiment, the identification signal can be a color display signal. The electronic device 112 of the user 104 can be loaded with software to enable the electronic device 112 to generate samples of color. The electronic device 112 can generate a recommended sample and can display it to the user.

After step 304, the user 104 can be given a choice to accept or reject the signal at step 306. The user 104 can accept the automatically selected identification signal or select another identification signal. If the user 104 accepts the automatically selected identification signal, the identification signal can be stored and marked as ‘in-use’ at step 312. If the user 104 decides to select another identification signal, the user 104 can choose between automatic and manual selection of identification signal at step 308. The manual selection of identification signal can be carried out at step 310. The selected identification signal can be stored and marked as ‘in-use’ at the step 312. The method 300 can end at step 314.

As an example of a manual selection, the user 104 may select a color sample from a table containing numerous samples of color, which can be displayed on the electronic device 112. It must be understood, however, that the invention is not limited to the selection of color when selecting the identification signal. There are many different options to choose from when determining the type of an identification signal for selection. Several other examples will be presented below.

Referring back to FIG. 2, once the identification signal has been selected at step 204, step 206 is performed. At step 206, the user 104 can send the selected identification signal to, for example, the electronic device 114 belonging to the individual 106. In response, the electronic device 114 can be selectively activated, as shown at step 208. The selective activation of the electronic device 114 can be done by activation of a color display signal, an audio signal, a vibratory signal, or a non-visible light signal based on the identification signal selected by the user 104. Based on the selective activation, the user 104 can identify the individual 106. The method 200 can end at step 210.

As an example, the electronic device 114 can be activated by activating its color display. As another example, the electronic device 114 can include a lighting element, such as a fiber optic element, that can be illuminated with a color when the electronic device 114 receives the identification signal.

Similarly, the electronic device 114 can include a speaker, a vibrator or a non-visible light source, one or more of which can be activated when the electronic device 114 receives the identification signal. For example, the identification signal can be associated with a song assigned to an individual. In such a case, the electronic device 114 can be activated by activating its speaker. In another example, the identification signal can be associated with a combination of a color display signal and a vibratory signal assigned to an individual. In such a case, the electronic device 114 can be activated by activating its color display and its vibrator.

In yet another example, selective activation of a non-visible light source of an electronic device can be performed to track the individuals without their knowledge. The activated non-visible light on the electronic device of the individual can be viewed by using special viewing instruments. These special viewing instruments include modern telescopic equipment using various filters and detectors, to detect ultraviolet light, infrared light, X-rays, or gamma rays. The path traced by the non-visible light can be used to track the individual. For example, there may be a case where a police officer wants to track an individual with suspected links without the knowledge of the individual.

In another embodiment of the invention, the method can be used to identify groups of people by sending the identification signal to the electronic devices of all the members of a group. The groups can be as large as an iDEN dispatch talk-group, or a smaller select group of individuals programmed as part of a Selective Dynamic Group Call (SDGC) group. For example, consider a case where an individual is in a nightclub dance floor with a group of friends. If the individual wants to identify his friends in the dimly-lit dance floor environment, he can send a request for displaying a color display signal via SDGC to his/her friends. Since the electronic devices of the individual and his friends will display the same color display signal, they can hold their phones up in the air and congregate.

Other group applications can be implemented as well. For example, an electronic device can include instant messaging or e-mail groups, which can be temporarily or permanently created. As another example, the electronic device can have other messaging applications, such as short messaging service and multimedia messaging service, which allow for individual or group sending of text or media content. Media can include one or more of audio, speech, video, images and text.

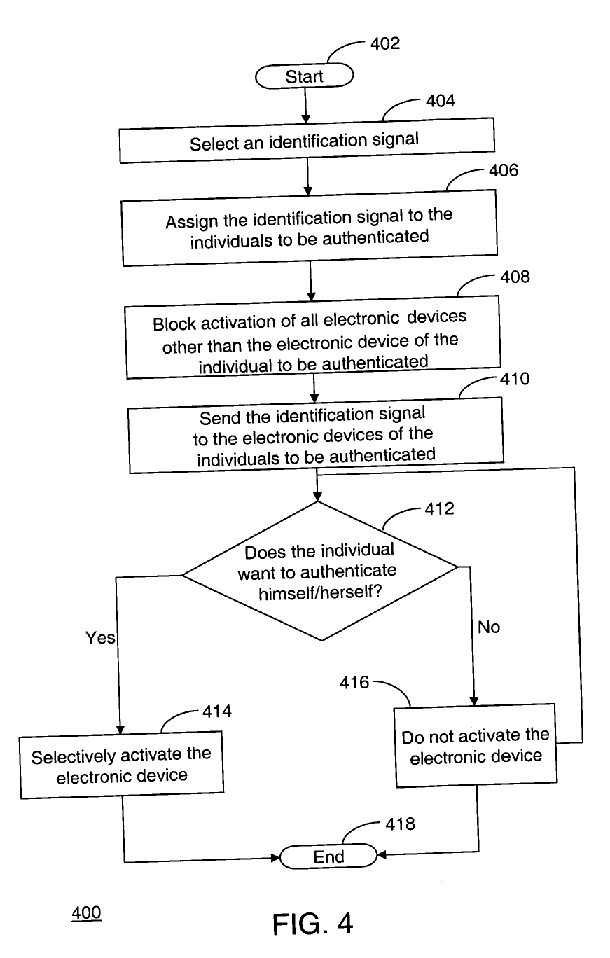

FIG. 4 shows an embodiment of the inventive arrangements, wherein the method can be used for authenticating individuals. For example, the user 104 needs to authenticate the individual 106. At step 402, the method can begin. At step 404, an identification signal can be selected. The selected identification signal can be assigned to the individual 106 at step 406. At step 408, the activation of all electronic devices other than the electronic device 114, which is the electronic device being used by the individual 106, can be blocked.

Further, at step 410, the identification signal can be sent to the electronic device 114. At step 412, it is determined whether the individual 106 wants to authenticate himself/herself. If the individual 106 wants to authenticate himself/herself, the electronic device 114 can be selectively activated, as shown at step 414. Otherwise, the electronic device 114 can be kept deactivated at step 416, and the procedure can be repeated from step 412 onwards. The method 400 can end at step 418.

In one embodiment of the invention, the display of a pre-assigned color display signal by an electronic device can authenticate an individual or a group of individuals. As an example, the invention can be used to provide time-restricted access to an area. In an embodiment of the invention, the display of the receiving electronic device may remain illuminated with the predefined color for a predefined time interval. Once this time period has expired or has been revoked, the display on the electronic device may no longer remain illuminated.

In another embodiment of the invention, the user 104 can use his electronic device to enable the electronic devices of the individuals to be identified, so that they display a color display signal based on the group or organization to which the individuals belong. Once a request or announcement for these individuals is made, they can push a button on their electronic devices to display the color display signal and identify themselves. Alternatively, the displays on the electronic devices can automatically illuminate in the selected color. As an example, in an emergency, the method can be used to locate law enforcement personnel or other emergency workers.

As another example, the color to be displayed can correspond to the function of the user of the receiving electronic device. For instance, if a policeman has a receiving electronic device, his display can illuminate in a blue color. A fireman's electronic device display can give off a red light. In yet another example, a predefined audio or vibrational sequence can be broadcast from the receiving electronic device in which the sequences correspond to the function of the user of the receiving electronic device. In particular, the electronic device of an emergency worker may broadcast emergency siren sounds from its speaker.

The manner in which the receiving electronic device is activated may also provide some indication as to the rank or some other signifying criteria relating to the user of the receiving electronic device. For example, the receiving electronic device of a high-ranking police officer may display both a blue light and a white light, which can provide an indication that this particular officer is, for example, a supervisor. Of course, the invention is not limited to any of these examples described above, as other suitable methods or processes to identify group members (and certain ranking criteria of the group members) are within contemplation of the inventive arrangements.

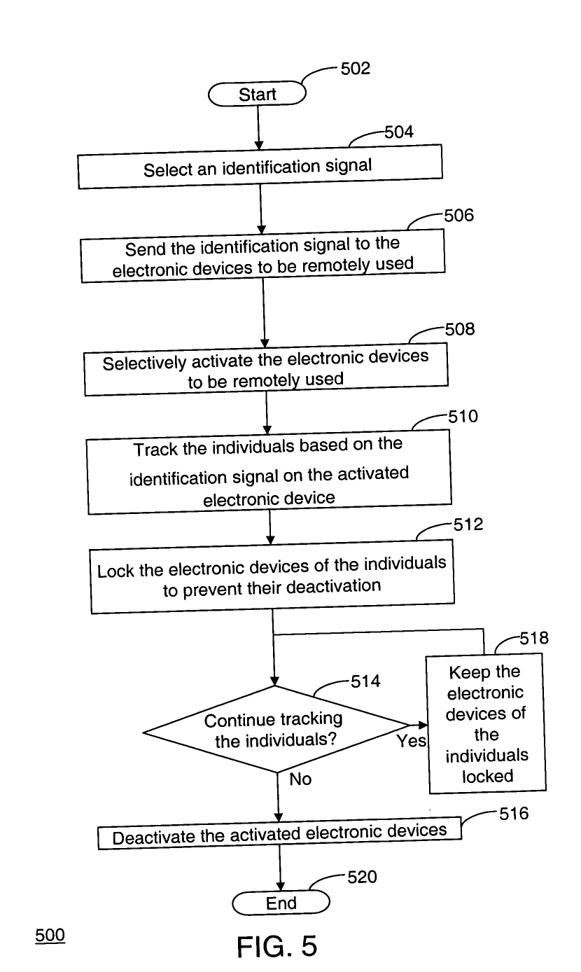

FIG. 5 shows another embodiment of the inventive arrangements, wherein the user 104 can employ the method described in the invention to remotely use another individual's electronic device for his/her own purpose. Consider an instance where the user 104 wants to remotely use the electronic device 114. At step 502, the method can begin. An identification signal is selected at step 504. The selected identification signal can be sent to the electronic device 114, belonging to the individual 106 at step 506.

The electronic device 114 is selectively activated based on the received identification signal, as shown at step 508. Based on the activation, the individual 106 can be tracked at step 510. Further, the electronic device 114 can be locked at step 512, wherein the deactivation of the activated electronic device can be prevented. At step 514, it can be determined whether the individual 106 needs to be tracked further.

If there is no need to further track the individual 106 then the identification signal can be deactivated at step 516. Otherwise, the electronic device 114 can be kept in the locked condition at step 518, and the process can resume again at step 514. The method can also be employed for more than one individual. The method 500 can end at step 520.

The user 104 can also set the instructions to control deactivation of the activated electronic device. In one embodiment of the invention, the user 104 can allow the individual 106 to disable the display of the electronic device 114 after a predefined time interval. In another embodiment of the invention, the user 104 can send a personal identification number (PIN) to lock out the individual 106 from disabling the display of the electronic device 114 until the individual 106 requests the PIN from the user 104.

The locking of the activated electronic devices such that their deactivation is prevented may remain in effect until a set of predefined conditions is satisfied. For example, the individual who sent the identification signal may wish to keep the electronic device that receives the identification signal in an activated state until the user of the activated electronic device is located. Of course, those of skill in the art will appreciate that there are many other examples of such predefined conditions.

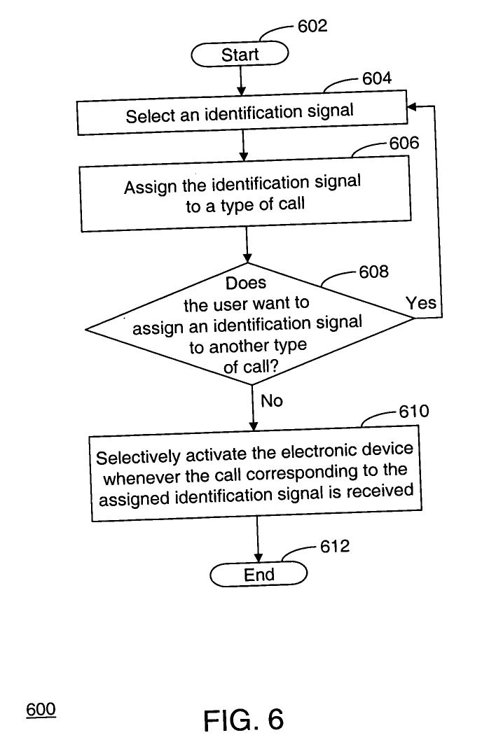

FIG. 6 shows another embodiment of the inventive arrangements in which the method can be used for identifying the type of incoming call. At step 602, the method can begin. An identification signal can be selected at step 604. The selected identification signal can be assigned to a type of call at step 606. At step 608, it can be determined whether the user 104 wants to assign an identification signal to another type of call. If the user 104 wants to assign another identification signal to another type of call, the user 104 can select another identification signal at the step 604. Otherwise, at step 610, the electronic device 112 can be selectively activated whenever the call corresponding to the assigned identification signal is received. In an embodiment of the invention, a different color display signal, based on signal-specific parameters, such as color brightness, turn on/off slopes and blinking patterns, can be assigned to different types of calls. The method 600 can end at step 612.

For example, the method can be used to distinguish a long-distance call from, say, a local call or an international call. In another embodiment, the method can be used to differentiate calls from different groups. For example, a manager in an organization can assign different identification signals to different teams and based on the identification signal, he can differentiate among the calls from different teams.

FIG. 7 shows an example of an electronic device 702 in which the method for identifying individuals can be implemented. The electronic device 702 can include a selection module 704, a communication module 706, a tracking module 708 and a deactivation module 710.

Selection module 704 can select an identification signal. Communication module 706 can send the selected identification signal to the electronic devices of individuals to be identified. Tracking module 708 can track the individuals by following the identification signal on the activated electronic devices. In an embodiment of the invention, tracking module can track individuals by tracking non-visible light. In this event, the system can be used to track individuals even without their knowledge.

Deactivation module 710 can deactivate the activated the electronic devices of the individuals to be identified. Deactivation module 710 can include a locking module 712. Locking module 712 can prevent the deactivation of the activated electronic devices.

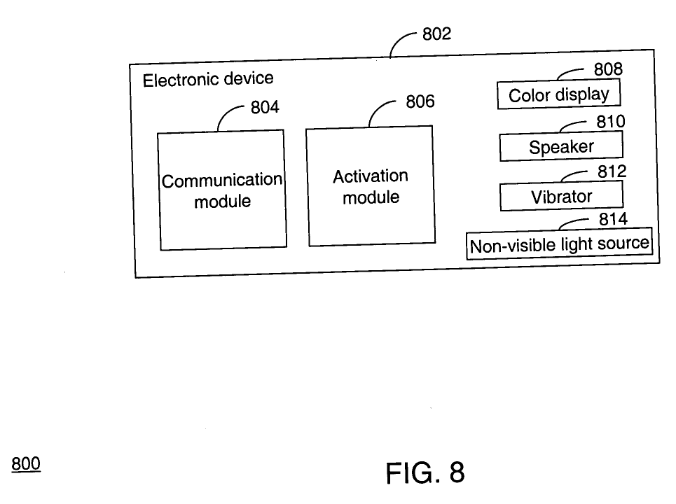

FIG. 8 shows an example of electronic device 802 that can be selectively activated in accordance with the descriptions above. The electronic device 802 can include a communication module 804, an activation module 806, a color display 808, a speaker 810, a vibrator 812 and a non-visible light source 814. The communication module 804 can receive an identification signal from an originating component. In one embodiment, the originating component can be the electronic device 702. The activation module 806 can selectively activate the color display 808, the speaker 810, the vibrator 812, or the non-visible light source 814 in response to the receipt of the identification signal. For example, if the user selects a color display signal having a blue color as the identification signal, the activation module 806 can activate the color display 808. The color display 808 can be illuminated with a blue color, along with the other parameters of the color display signal, if so present. The identification signal on the activated electronic device can be tracked by the originating component, in order to track or identify the individual carrying the electronic device 802.

The location of the electronic devices may also be a factor in determining if the devices will be activated. For example, as part of the process of selecting an identification signal, a user, through any suitable user interface of his electronic device, may decide to only activate those electronic devices that are within a certain radius of his electronic device. Alternatively, the user may decide to only activate those electronic devices that are located at a particular building, address or a predetermined set of geopositional coordinates.

Any suitable process can be used to determine the location of the electronic devices that may be activated. For example, the electronic device of the user who wishes to cause the activation may receive the GPS coordinates of such electronic devices, which can enable it to determine if these devices are within the predetermined geographic region. Those of skill in the art will appreciate that other suitable processes may be employed to determine the location of electronic devices that may be activated.

Although the invention has been described in terms of identifying humans, it is understood that the invention can be used to identify machinery or animals. For example, one or more machines may be outfitted with electronic devices capable of receiving communication signals. As such, a worker looking for a particular machine may select and send an identification signal to the electronic device that corresponds to this machine. When the electronic device activates, the worker may locate the preferred machine. A similar feature can be used to identify one or more animals, too.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for identifying one or more individuals in a crowd, the crowd comprising one or more individuals, the method comprising:
selecting an identification signal;
sending the identification signal, the identification signal being sent to the electronic devices of one or more individuals to be identified;
selectively activating the electronic devices of the one or more individuals to be identified to allow a user to identify one or more of the individuals, wherein selectively activating the electronic devices includes selectively activating a color display, a speaker, a vibrator, or a non-visible light source of the electronic devices of the one or more individuals to be identified; and
tracking the location of the one or more individuals to be identified, without the knowledge of the one more individuals to be identified.

2. (canceled)

3. The method of claim 1, wherein selectively activating the color display comprises selectively activating the color display such that a predetermined color display signal or a predetermined pattern is displayed based on functions of the one or more individuals.

4. (canceled)

5. The method of claim 1, wherein tracking the location of the one or more individuals to be identified comprises activating the non-visible light sources of the electronic devices of the one or more individuals to be identified.

6. The method of claim 1, wherein the electronic devices of the one or more individuals to be identified are mobile devices.

7. The method of claim 1, further comprising deactivating the activated electronic devices, the deactivation of the activated electronic devices of the one or more individuals to be identified being done after the one or more individuals have been identified.

8. The method of claim 7, further comprising locking the electronic devices of the one or more individuals to be identified, wherein the deactivation of the activated electronic devices of the one or more individuals to be identified is prevented until a set of predefined conditions is satisfied.

9. The method of claim 1, wherein selecting the identification signal comprises selecting the identification signal through an electronic device or a network.

10. The method of claim 1, wherein selectively activating the electronic devices comprises selectively activating the electronic devices of the one or more individuals to be identified when the electronic devices are within a predetermined geographic region.

11. An electronic device for identifying one or more individuals in a crowd, the crowd comprising one or more individuals, the electronic device comprising:
i. a selection module, wherein the selection module selects an identification signal that is used to identify one or more individuals in the crowd;
ii. a communication module, wherein the communication module sends the identification signal to other electronic devices of the one or more individuals to be identified; and
iii. a tracking module, wherein the tracking module tracks the location of the one or more individuals to be identified, without the knowledge of the one or more individuals;
wherein the identification signal activates an activation module on the other electronic devices of the one or more individuals to be identified by selectively activating a color display, a non-visible light source, a speaker, or a vibrator of the other electronic devices of the one or more individuals to be identified to allow a user to identify one or more of the individuals.

12. (canceled)

13. The electronic device of claim 11, wherein the identification signal selectively activates the color display such that a predetermined color display signal or a predetermined pattern is displayed based on functions of the one or more individuals.

14. (canceled)

15. The electronic device of claim 11, wherein the identification signal activates the non-visible light sources on the electronic devices of the one or more individuals to be identified and the tracking module tracks the non-visible light.

16. The electronic device of claim 11, wherein the electronic device is a mobile device.

17. The electronic device of claim 11, further comprising a deactivation module, the deactivation module deactivates the activated electronic devices of the one or more individuals to be identified, after the one or more individuals have been identified.

18. The electronic device of claim 17, wherein the deactivation module comprises a locking module, the locking module prevents the deactivation of the activated electronic devices of the one or more individuals to be identified until a set of predefined conditions is satisfied.

19. An electronic device for identifying one or more individuals in a crowd, the crowd comprising one or more individuals, the electronic device comprising:
i. a communication module, wherein the communication module receives, from an originating component, an identification signal that is used to identify one or more individuals in a crowd having the electronic device; and
ii. an activation module, wherein the activation module activates in response to the receipt of the identification signal to allow a user to identify the one or more individuals having the electronic device, and wherein the activation module selectively activates a color display, a speaker, a vibrator, or a non-visible light source of the electronic device, based on the identification signal from the originating component; and
iii. a tracking module, wherein the tracking module tracks the location of the one or more individuals to be identified, without the knowledge of the one or more individuals.

20. (canceled)
